(19) United States
(12) Patent Application Publication
(10) Pub. No.: US 2008/0067006 A1
(43) Pub. Date: Mar. 20, 2008

(54) Elevator System

(75) Inventors: Shiro Hikita, Tokyo (JP); Kiyoji Kawai, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Mitsubishi Electric, Tokyo (JP)

(21) Appl. No.: 11/576,187

(22) PCT Filed: Sep. 16, 2005
(86) PCT No.: PCT/JP05/17160

§ 371 Date: Mar. 28, 2007

(51) Int. Cl. G05B 15/00; B66B 1/28; B66B 5/02

(52) U.S. Cl. 187/247; 187/392

(57) ABSTRACT

In an elevator system, an evacuation elevator control portion devises an evacuation plan making use of elevators based on disaster information in the event of a disaster, and outputs a command to perform evacuation operation, which is based on the evacuation plan, to an elevator operation control portion. The evacuation elevator control portion monitors an evacuation situation resulting from evacuation operation, and transmits information on the evacuation situation to the outside.

### TECHNICAL FIELD

The present invention relates to an elevator system for performing evacuation operation control for an elevator in the event of a disaster in a building, for example, a fire or the like.

### BACKGROUND ART

In a conventional elevator system, a car is moved to a nearest floor and then is brought out of operation when, for example, a fire breaks out in a building. In recent years, however, fireproof compartmentalization technology and the like for buildings have been improved, so a fire has little influence on a floor unless the floor is a source of the fire or a floor located close thereto. Thus, there is proposed an elevator system for devising an evacuation method utilizing an elevator based on information on a floor as a source of a fire so as to avert the influence of the fire and performing evacuation operation based on the evacuation method (e.g., see Patent Document 1).

Patent Document 1: JP 2005-104630 A

### DISCLOSURE OF THE INVENTION

### Problem to be Solved by the Invention

With the conventional elevator system constructed as described above, however, fire brigade members sent to a building in response to a report about the occurrence of a disaster (i.e., a man-made disaster or a natural disaster such as a fire, an earthquake, a flood disaster or the like) cannot swiftly grasp an evacuation situation about people remaining inside the building after the occurrence of the disaster, and need to start engaging in rescue/firefighting operations after having obtained information on the people remaining inside the building and information on the evacuation situation from a disaster prevention worker of the building or the like. Therefore, the fire brigade members are hard-pressed to engage in the rescue/firefighting operations.

The present invention has been made to solve the above-mentioned problem, and it is therefore an object of the present invention to obtain an elevator system capable of more swiftly informing rescue workers of an evacuation situation about people remaining inside a building after the occurrence a disaster and reducing the burden in performing rescue operations.

### Means for Solving the Problem

An elevator system according to the present invention includes an evacuation elevator control portion for devising an evacuation plan making use of elevators based on disaster information in an event of a disaster, outputting a command to perform evacuation operation based on the evacuation plan to an elevator operation control portion, monitoring an evacuation situation resulting from the evacuation operation, and transmitting information on the evacuation situation to an outside.

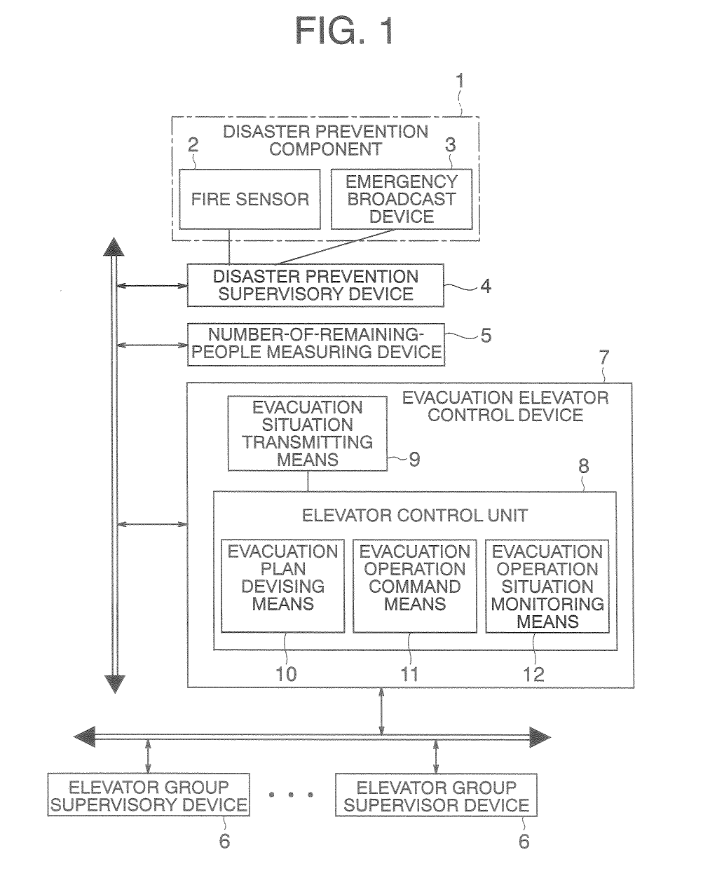

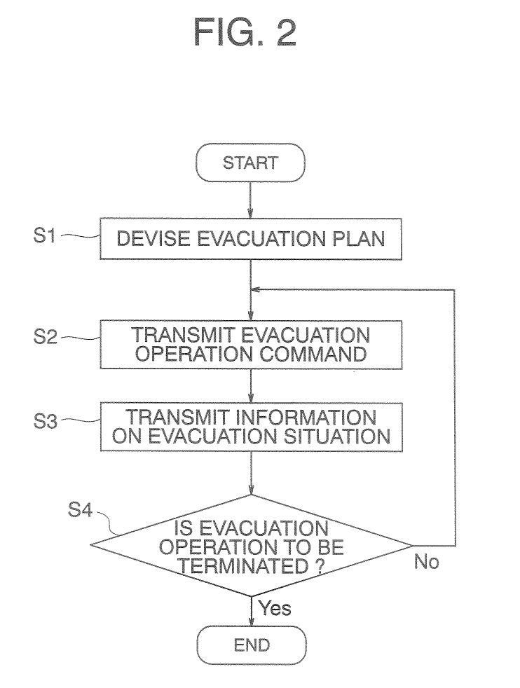

### BRIEF DESCRIPTION OF THE DRAWINGS

[FIG. 1] FIG. 1 is a block diagram showing an elevator system according to Embodiment 1 of the present invention.

[FIG. 2] FIG. 2 is a flowchart showing an operation of an evacuation elevator control device of FIG. 1.

### BEST MODE FOR CARRYING OUT THE INVENTION

A preferred embodiment of the present invention will be described hereinafter with reference to the drawings.

### Embodiment 1

FIG. 1 is a block diagram showing an elevator system according to Embodiment 1 of the present invention. Various kinds of disaster prevention components 1 are provided in a building. The disaster prevention components 1 include a plurality of fire sensors 2 installed at respective floors, and a plurality of emergency broadcast devices 3 installed at the respective floors. The emergency broadcast devices 3 broadcast an announcement about emergency evacuation guidance and the like.

These disaster prevention components 1 are supervised and controlled by a disaster prevention supervisory device 4. In the building, a number-of-remaining-people measuring device 5 for measuring the number of people remaining at the respective floors inside the building is provided as part of a building supervisory system. The number-of-remaining-people measuring device 5 measures the number of people remaining inside the building by, for example, processing image data acquired from cameras. The number-of-remaining-people measuring device 5 can also extract the number of wheelchair users and the number of children based on the image data

Furthermore, a plurality of elevator group supervisory devices 6 as an elevator operation control portion for supervising operations of a plurality of elevators included in corresponding groups respectively are provided in the building. An evacuation elevator control device 7 as an evacuation elevator control portion for performing evacuation operation control making use of the elevators in the event of a fire is connected to the elevator group supervisory devices 6 via a local area network (LAN). The evacuation elevator control device 7 is also connected to the disaster prevention supervisory device 4 and the number-of-remaining-people measuring device 5 via a LAN.

The evacuation elevator control device 7 has an elevator control unit 8 for performing evacuation operation control, and evacuation situation transmitting means 9 for transmitting information from the elevator control unit 8 to an external (i.e., remote) communication device (i.e., an external computer environment).

The elevator control unit 8 has evacuation plan devising means 10, evacuation operation command means 11, and evacuation operation situation monitoring means 12. The evacuation plan devising means 10 devises an evacuation plan making use of the elevators based on fire information (i.e., information on a place where a fire has broken out) from the disaster prevention supervisory device 4 in the event of the fire. The evacuation operation command means 11 transmits an evacuation operation command, which is based on the evacuation plan devised by the evacuation plan devising means 10, to the elevator group supervisory devices 6.

The evacuation operation situation monitoring means 12 refers to the number of people getting on the elevators at a rescue floor and the number of people getting off the elevators at an evacuation floor to grasp and monitor an evacuation situation. Information on the evacuation situation grasped by the evacuation operation situation monitoring means 12 is transmitted from the evacuation situation transmitting means 9 to the external communication device. The information on the evacuation situation includes, for example, information on an activity situation about the elevators subjected to evacuation operation (i.e., information indicating which ones of the elevators are active), information indicating which ones of the floors are the rescue floor and the evacuation floor respectively, information on the number of people getting on the elevators at each rescue floor, information on the number of people getting off the elevators at the evacuation floor, and the like.

The number of people getting on the elevators and the number of people getting off the elevators can be calculated from, for example, information from load weighing devices provided at cars. The current number of people remaining at each floor can also be calculated by the evacuation elevator control device 7 through subtraction of information on the number of people getting on the elevators from information on the number of people remaining inside the building, which has been obtained from the number-of-remaining-people measuring device 5, and can be transmitted from the evacuation situation transmitting means 9 as information on an evacuation situation.

The evacuation operation situation monitoring means 12 can also process image data from cameras within the cars to determine whether or nor wheelchair users or children have got on the cars, and compare the image data with the information from the number-of-remaining-people measuring device 5 to grasp an evacuation situation about the wheelchair users and the children. Accordingly, the information on the evacuation situation about the wheelchair users and the children can also be transmitted from the evacuation situation transmitting means 9.

The evacuation elevator control device 7 is designed as a computer having a calculation processing portion (CPU), a storage portion (a ROM, a RAM, a hard disk, or the liked), and signal input/output portions. The functions of the evacuation situation transmitting means 9, the evacuation plan devising means 10, the evacuation operation command means 11, and the evacuation operation situation monitoring means 12 are realized by the computer. In other words, control programs for realizing the functions of the means 9 to 12 are stored in the storage portion of the computer. The disaster prevention supervisory device 4 and the elevator group supervisory devices 6 are also designed as computers that are independent of one another.

Next, an operation will be described. FIG. 2 is a flowchart showing the operation of the evacuation elevator control device 7 of FIG. 1. When the fire sensors 2 or the like have sensed and confirmed the occurrence of a fire, the disaster prevention supervisory device 4 informs a predetermined fire department of the occurrence of the fire. The evacuation elevator control device 7 may inform the firer department of the occurrence of the fire instead.

When the occurrence of the fire is confirmed, the evacuation plan devising means 10 devises an evacuation plan making use of the elevators (step S1). Then, an evacuation command based on this evacuating plan is transmitted from the evacuation operation command means 11 to the elevator group supervisory devices 6 (step S2). Thus, evacuation operation of the elevators is performed, and evacuation guidance and the like are carried out by the emergency broadcast devices 3 through the disaster prevention supervisory device 4.

The evacuation situation is monitored by the evacuation operation situation monitoring means 12, and information on the evacuation situation is transmitted from the evacuation situation transmitting means 9 to the outside (step S3). More specifically, data on the evacuation situation are transmitted to, for example, a computer as a communication device installed at a fire department, a computer as a communication device carried about by a fire brigade member, or the like. Mentionable as a method of transmitting the data are, for example, a method of transmitting the data to a pre-registered mail address as an e-mail, a method of transmitting/writing the data to/into a pre-registered URL address through the Internet line, and the like.

If predetermined fire brigade members are informed of a password and received information on an evacuation situation is made browsable only when the correct password is input, leakage of the information can be prevented.

A fire brigade member can obtain information from the evacuation elevator control device 7 by receiving a report from a fire department or directly checking a computer he carries about. Immediately after having arrived at a scene of a fire (while moving to the scene of the fire in some cases), the fire brigade member can figure out an evacuation situation about people remaining inside the building.

The information on the evacuation situation is repeatedly transmitted on a predetermined cycle. After the information has been transmitted, it is confirmed whether to terminate evacuation operation or not (step S4). When evacuation operation is not terminated, an evacuation operation command and the evacuation situation information continue to be transmitted.

Conceivable as conditions for determining that evacuation operation is to be terminated are, for example, the following conditions.

(i) Someone such as a fire brigade member, a disaster prevention worker, or the like determines that an evacuation/rescue activity should be terminated, and a command to terminate the operation should be manually input.

(ii) It is difficult to continue the operations of the elevators due to some cause such as the propagation of a fire, water immersion resulting from fire fighting, or the like.

(iii) No one is on the elevators at a rescue floor any more, and it is determined that evacuation has been completed.

The conditions (ii) and (iii) may either be automatically determined/input based on information from sensors fitted to the elevators such as passenger loading/unloading sensors, or be manually input based on someone's judgment.

In the elevator system configured as described above, the evacuation elevator control device 7 not only devises an evacuation plan and outputs an evacuation operation command but also monitors an evacuation situation and transmits information on the evacuation situation to the outside. Therefore, fire brigade members can be swiftly informed of the evacuation situation about people remaining inside the building after the occurrence of a fire, so their burden in performing rescue/fire/firefighting operations can be reduced.

In the foregoing examples, the evacuation elevator control device 7 designed as the independent computer is illustrated as the evacuation elevator control portion. However, the evacuation elevator control portion is not necessarily required to be designed as an independent component. In a case where, for example, there is only one elevator group supervisory device inside the building, a computer constituting the elevator group supervisory device can be designed to perform the functions of the evacuation elevator control portion. In some cases, the component such as the disaster prevention supervisory device or the like can also be designed to perform the functions of the evacuation elevator control portion.

The functions of the evacuation elevator control portion such as devisal of an evacuation plan, issuance of an evacuation operation command, monitoring of an evacuation operation situation, transmission of an evacuation situation, and the like can also be allocated to a plurality of computers to be performed separately.

Although the foregoing example describes the case of the fire as a disaster, the present invention is also applicable to, for examples an earthquake, a flood disaster, and the like.

1: An elevator system comprising an evacuation elevator control portion for devising an evacuation plan making use of an elevator based on disaster information in an event of a disaster, outputting a command to perform evacuation operation, based on the evacuation plan to an elevator operation control portion, monitoring an evacuation situation resulting from the evacuation operation, and transmitting information on the evacuation situation to an outside.

2: An elevator system according to claim 1, wherein the evacuation elevator control portion repeatedly transmits the information on the evacuation situation on a predetermined cycle in the event of the disaster.

3: An elevator system according to claim 1, wherein the evacuation elevator control portion monitors/transmits information on an operation situation of the elevator which is subjected to the evacuation operation as the information on the evacuation situation.

4: An elevator system according to claim 1, wherein the evacuation elevator control portion monitors/transmits information on a number of people getting on the elevator at a rescue floor and information on a number of people getting off the elevator at an evacuation floor as the information on the evacuation situation.

5: An elevator system according to claim 4, wherein the evacuation elevator control portion calculates the number of the people getting on the elevator at the rescue floor and the number of the people getting off the elevator at the evacuation floor from information obtained from a load weighing device provided at a car of the elevator.

6: An elevator system comprising:
an elevator operation control portion for operating an elevator according to a command to perform evacuation operation based on an evacuation plan making use of the elevator by devising the evacuation plan based on disaster information in an event of a disaster and to receive the command.

7: An elevator system comprising:
an evacuation elevator control portion for devising an evacuation plan making use of an elevator based on disaster information in an event of a disaster, and generating a command to perform evacuation operation, based on the evacuation plan; and
an elevator operation control portion for operating an elevator according to the command.

8: An elevator control method for evacuating people remaining inside a building by using an elevator in an event of a disaster, comprising:
devising an evacuation plan making use of the elevator based on disaster information; and
operating the elevator according to the evacuation plan.

9: The elevator control method according to claim 8, further comprising monitoring an evacuation situation of people remaining inside the building and transmitting information on the evacuation situation to an outside.
